(19) United States
(12) Patent Application Publication
(10) Pub. No.: US 2024/0388525 A1
(43) Pub. Date: Nov. 21, 2024

(54) METHOD AND APPARATUS FOR SCP DOMAIN ROUTING LOOPING

(71) Applicant: Telefonaktiebolaget LM Ericsson (publ), Stockholm (SE)

(72) Inventors: Yunjie LU, Shanghai (CN); Magnus HALLENSTÅL, Täby (SE); Maria Cruz BARTOLOME RODRIGO, Torremocha de Jarama Madrid (ES)

(73) Assignee: Telefonaktiebolaget LM Ericsson (publ), Stockholm (SE)

(21) Appl. No.: 18/033,299

(22) PCT Filed: Oct. 12, 2021
(86) PCT No.: PCT/EP2021/078099

§ 371 Date: Apr. 21, 2023

(30) Foreign Application Priority Data
Oct. 23, 2020 (WO) PCT/CN2020/123262

(51) Int. Cl. H04L 45/18; H04L 67/562; H04L 67/563

(52) U.S. Cl. CPC H04L 45/18; H04L 67/562; H04L 67/563

(57) ABSTRACT

Various embodiments of the present disclosure provide a method for detect dead loop in the routing path. The method which may be performed by a first Service Communication Proxy comprises receiving from a second SCP or NF a request message comprising original routing path detection information to detect dead loop in the routing path. The method further comprises determining dead loop based on the routing path detection information. The method another further comprises generating new routing path detection information and sending towards the third SCP the request message. According to the embodiments of the present disclosure, the efficiency of pathing finding for SCP domains can be improved.

### FIELD OF THE INVENTION

The present disclosure generally relates to communication networks, and more specifically, to service communication proxy domain routing looping.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE)/fourth generation (4G) network and new radio (NR)/fifth generation (5G) network are expected to achieve high traffic capacity and end-user data rate with lower latency. To meet the diverse requirements of new services across a wide variety of industries, the 3rd generation partnership project (3GPP) is developing a core network architecture such as evolved packet core (EPC) or 5G core (5GC), which is supposed to support the wide range of performance requirements demanded by new business opportunities, multiple access technologies, a variety of services and new device types. In Rel-16, 3GPP has specified Service Communication Proxy (SCP) as part of the Enhanced Service Based Architecture (eSBA). To manage service access, SCP domain was introduced which consists SCPs and NFs, where any SCP in the SCP domain can directly access the Network Function(s) (NFs) or other SCPs within the same SCP domain. Furthermore, an SCP can bridge SCP domains it belongs to, i.e. the SCP domains are connected, which allows a NF consumer in one SCP domain may access NF producer in another SCP domain via multiple SCP(s). The SCP Domain is described in 3GPP as: A configured group of one or more SCP(s) and zero or more NF instances(s), an SCP within the group can communicate with any NF instance or SCP within the same group directly, i.e., without passing through an intermediate SCP. If an SCP belongs to more than one SCP Domain, the SCP will be able bridge these domains, i.e. sending messages between these domains.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

When a request message is being relayed to the target SCP domain, the routing path may be incorrectly going to dead looping, e.g., due to misconfiguration of SCPs or misbehavior of certain SCP in the chain: If this happens, the request message will be forwarded infinitely in the network, which leads to: Service interruption due to the message never reaching the target NF; exceptionally increasing the network load for relaying the dead messages. Therefore, it may be desirable to improve the efficiency of pathing finding for SCP domains.

Various embodiments of the present disclosure propose a solution which may detect the message routing path dead looping and inform the management system (e.g., logging/event/warning, etc.). The SCPs or the management system may update the configuration in to fix the misconfiguration to avoid future wrong routing. Therefore, the solution may avoid service interruption and decrease the network load by avoiding relaying the dead messages and may improve the efficiency of path finding in the SCP routing.

According to a first aspect of the present disclosure, there is provided a method performed by a first Service Communication Proxy, SCP (214, 314). The method comprises receiving, from a second SCP, (212, 312) or a Network Function, NF, (210, 310) a request message comprising original routing path detection information wherein the routing path detection information is used to detect dead loop in the routing path. The method further comprises determining if the routing path is a dead loop based on the original routing path detection information when the next hop is a third SCP (216, 316). The method another further comprises, in response to determining result indicating that the routing path is not dead looping, generating (406) new routing path detection information based on the original routing path detection information, and sending (408), towards the third SCP, (216, 316) the request message comprising the new routing path detection information. The method another further comprises, in response to determining result indicating that the routing path is dead looping, sending a response message towards the second SCP (212, 312) or the NF (210, 310) indicating that the request message is rejected.

In accordance with an exemplary embodiment, the original routing path detection information may comprise a value indicating maximum number of allowed intermediate SCPs to relay the message.

In accordance with an exemplary embodiment, the determining if the routing path is dead looping may comprise the determining result indicating that the routing path is dead looping when the value indicating no more allowed intermediate SCPs to relay the message; or the determining result indicating that the routing path is not dead looping when the value indicating there is allowed intermediate SCPs to relay the message.

In accordance with an exemplary embodiment, the generating new routing path detection information may comprise decrementing the allowed intermediate SCPs number by 1 to set the new routing path detection information when the value indicating there is allowed intermediate SCPs.

In accordance with an exemplary embodiment, the request message may be a Hypertext Transfer Protocol, HTTP, message and the HTTP message header may comprise the routing path detection information indicating the maximum number of allowed SCPs to relay the request message to the HTTP server when indirect communication is used.

In accordance with an exemplary embodiment, the response message may comprise response code and/or application error indicating the reason of rejecting the request message; the application error may comprise value to indicate the request is rejected due to the maximum number of allowed SCPs has been reached before reaching a target Network Function.

In accordance with an exemplary embodiment, the original routing path detection information may comprise one or more recorded SCP domains and/or SCP Ids indicating the SCP domains or SCP Ids within which the message is being bridged.

In accordance with an exemplary embodiment, the determining if the routing path is a dead loop may comprise the determining result indicating that the routing path is a dead loop when the SCP domain associated to the third SCP is within the recorded SCP domains or the SCP Id of the third SCP is within the recorded SCP Ids; the determining result indicating that the routing path is not a dead loop when the SCP domain associated to the third SCP is not within the recorded SCP domains and the SCP Id of the third SCP is not within the recorded SCP Ids.

In accordance with an exemplary embodiment, the generating new routing path detection information may comprise inserting the SCP domain associated to the first SCP into the recorded SCP domains and/or inserting the SCP Id of the first SCP into the recorded SCP Ids when the determining result indicates that the routing path is not a dead loop.

According to a second aspect of the present disclosure, there is provided an apparatus which may be implemented as a SCF. The apparatus may comprise one or more processors and one or more memories comprising computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a SCP. The apparatus comprises a receiving unit, a determining unit, a generating unit and a sending unit. In accordance with some exemplary embodiments, the receiving unit may be operable to carry out at least the receiving step of the method according to the first aspect of the present disclosure. The determining unit may be operable to carry out at least the determining step of the method according to the first aspect of the present disclosure. The generating unit may be operable to carry out at least the generating step of the method according to the first aspect of the present disclosure. The sending unit may be operable to carry out at least the sending step of the method according to the first aspect of the present disclosure.

According to a fifth aspect of the present disclosure, there is provided a method performed by a second SCP (212, 312) or a Network Function, NF (210, 310). The method comprises sending, towards a first SCP (214, 314), a request message comprising original routing path detection information wherein the routing path detection information is used to detect dead loop in the routing path. The method further comprises, receiving, from the first SCP (214, 314), a response message when the request message is rejected by the first SCP (214, 314). The method further comprises transmitting the response message to another SCP or NF when the request message is received from the another SCP or NF.

In accordance with an exemplary embodiment, wherein the original routing path detection information comprises a value indicating allowed intermediate SCPs to relay the message.

In accordance with an exemplary embodiment, the request message may be a HTTP message and the HTTP message header may comprise the value of the routing path detection information indicating the maximum number of allowed SCPs to relay the request message to the HTTP server when indirect communication is used.

In accordance with an exemplary embodiment, the response message may comprise response code and/or application error indicating the reason of rejecting the request message, the application error may comprise information to indicate the request is rejected due to the maximum number of allowed SCPs has been reached when relaying the request message to a target Network Function.

In accordance with an exemplary embodiment, the original routing path detection information may comprise one or more recorded SCP domains and/or SCP Ids indicating the SCP domains or SCP Ids within which the request message is being bridged.

In accordance with an exemplary embodiment, the method according to the second aspect of the present disclosure may further comprise: after receiving, from the first SCP, a response message indicating the first SCP rejects the request message, sending the request message to other SCP domain(s) or SCP Id which is not present in the recorded SCP domains or SCP Ids.

In accordance with an exemplary embodiment, the method according to the second aspect of the present disclosure may further comprise: informing information of dead loop in routing path to an operating and managing system and/or NF indicating the operating and managing system and/or NF update or fix misconfiguration for the routing path when all SCP domains that can reach target NF by configuration have been tried unsuccessfully.

In accordance with an exemplary embodiment, the method according to the second aspect of the present disclosure may further comprise: the original routing path detection information is obtained from a message transmitted from another SCP or NF; or from configuration information when the original routing path detection information is not received from another SCP or NF.

According to a sixth aspect of the present disclosure, there is provided an apparatus which may be implemented as a SCP. The apparatus may comprise one or more processors and one or more memories comprising computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a SCP or NF. The apparatus may comprise a sending unit, a receiving unit and a transmitting unit. In accordance with some exemplary embodiments, the sending unit may be operable to carry out at least the sending step of the method according to the fifth aspect of the present disclosure. The receiving unit may be operable to carry out at least the receiving step of the method according to the fifth aspect of the present disclosure. The transmitting unit may be operable to carry out at least the transmitting step of the method according to the fifth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating the routing path may be incorrectly going to dead looping;

FIG. 2 is a diagram illustrating an exemplary procedure for detection dead loop in SCP routing according to some embodiments of the present disclosure;

FIG. 3 is diagram illustrating another exemplary procedure for detection dead loop in SCP routing according to some embodiments of the present disclosure;

FIG. 4 is a flowchart illustrating a method according to some embodiments of the present disclosure;

FIG. 5 is a flowchart illustrating another method according to some embodiments of the present disclosure;

FIG. 6 is a block diagram illustrating an apparatus according to some embodiments of the present disclosure;

FIG. 7 is a block diagram illustrating yet another apparatus according to some embodiments of the present disclosure;

FIG. 8 is a block diagram illustrating further another apparatus according to some embodiments of the present disclosure;

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future. A network function, network node, network entity, SCP used here can be implemented either as a network element on a dedicated hardware, as a software instance running on a dedicated hardware, or as a virtualized function instantiated on an appropriate platform, e.g., on a cloud infrastructure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

In Rel-16.5.0, 3GPP has specified Service Communication Proxy (SCP) as part of the Enhanced Service Based Architecture (eSBA). To manage service access, SCP domain was introduced which consists SCPs and NFs, where any SCP in the SCP domain can directly access the NFs or other SCPs within the same SCP domain. Furthermore, an SCP can bridge SCP domains it belongs to, i.e. the SCP domains are connected, which allows a NF consumer in one SCP domain may access NF producer in another SCP domain via multiple SCP(s). If a NFc sends a request to an NFp in another SCP domain which are not directly connected, intermediate SCPs will be needed to relay the message. Multiple SCP domains may be needed in the routing path. However, in some scenarios, the routing path may be incorrectly going to dead looping.

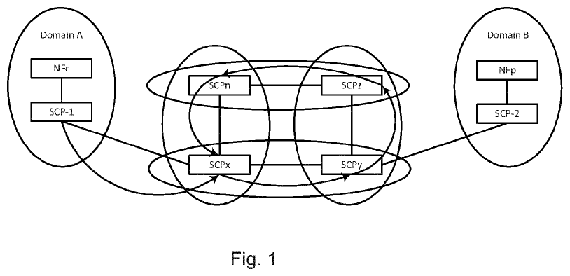

FIG. 1 is a diagram illustrating an exemplary procedure that the routing path may be incorrectly going to dead looping. The NFc and SCP-1 belong to same Domain A; the NFp and SCP-2 belong to the same Domain B; SCPx, SCPy, SCPz and SCPn are intermediate SCP(s) which enable the NFc can access the NFp via the intermediate SCP(s). When a request message is being relayed to the target SCP domain, in some scenarios, for example, due to misconfiguration of SCPs or misbehavior of certain SCP in the chain, the routing path as indicated in the FIG. 1 becomes from SCP1, SCPx, SCPy, SCPz, SCPn to SCPx. In this scenario, the routing path is incorrectly going to dead looping and it may lead to service interruption and exceptionally increasing of network load for relaying the dead messages.

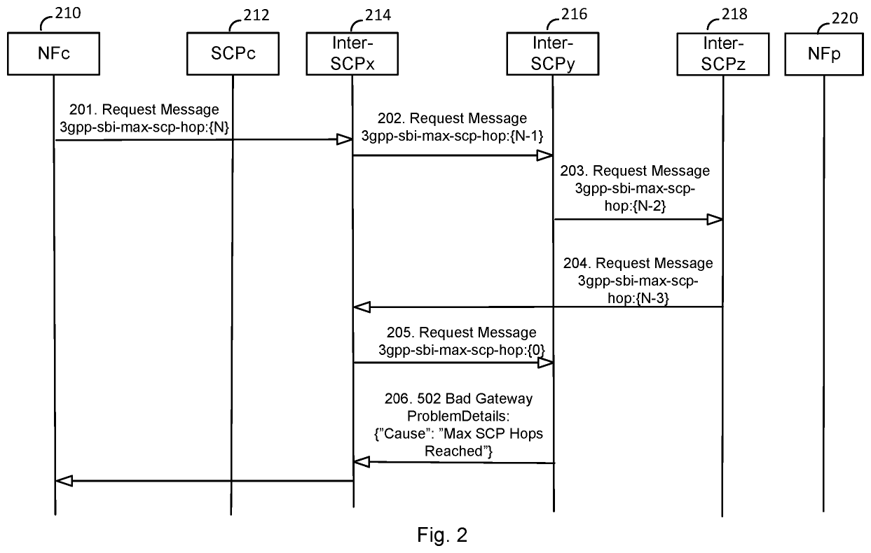

FIG. 2 is a diagram illustrating an exemplary procedure for detection dead looping in SCP routing according to some embodiments of the present disclosure. NFc (210) and SCPc (212) belong to same Domain, SCPx (214), SCPy (216) and SCPz (218) are intermediate SCP(s) which can bridge the request message from the SCPc (212) to the NFp (220). As shown in FIG. 2, in the step 201, the NFc (210) sends request message to SCPx (214) via the SCPc (212), the request message comprises the original routing path detection information to detect dead looping in the routing path and the value of the original routing path detection information is set to N, the value N indicates the maximum number of allowed intermediate SCPs to relay the message.

[symbol] .

The SCPx (214) receives the request message from the SCPc (212) in the step 201. The next SCP hop is the SCPy (216) based on the routing path, the SCPx (214) determines if the routing path is dead looping based on the original routing path detection information. The SCPx (214) receives the current value of maximum number of allowed SCPs (i.e., N) in the step 201, then the next SCP hops is allowed to relay the message. The SCPx (214) generates the new routing path detection information by decrementing the allowed intermediate SCPs number by 1 to set the new routing path detection information (i.e., N−1). Then the SCPx (214) sends the request message comprising the new routing path detection information with value N−1 towards the SCPy (216) in step 202.

In accordance with an exemplary embodiment, the SCPc (212) may obtain the value N from a message received from NFc (210).

In accordance with an exemplary embodiment the SCPc (212) may obtain the value N from the configuration information.

In accordance with an exemplary embodiment, the SCPx (214) may receive the request message from a NF.

In accordance with an exemplary embodiment, the request message may be a HTTP request message and the HTTP message header may comprise 3gpp-sbi-max-scp-hop: {N}, the value N of 3gpp-sbi-max-scp-hop indicates the allowed maximum number of SCPs hops is N, to relay the request message to the HTTP server when indirect communication is used.

The SCPy (216) receives the request message from SCPx (214) in step 202. The next SCP hop is the SCPz (218) based on the routing path, similar as the description above, the SCPy (216) decrements the allowed intermediate SCP hop number by 1 to set the new routing path detection information as N−2, and sends the request message comprising the new routing path detection information with value N−2 towards the SCPz (218) in step 203.

The SCPz (218) receives the request message from SCPy (216) in step 203, the next SCP hop is the SCPx (214) based on the routing path, similar as the description above, the SCPz (218) decrements the allowed intermediate SCP hop number by 1 to set the new routing path detection information as N−3, and sends the request message comprising the new routing path detection information with value N−3 towards the SCPx (214) in step 204.

The SCPx (214) receives the request message from SCPz (218) in step 204. It is noted, it may have some more SCP hops before the SCPz (218) sends the request message to SCPz (218), which is not illustrated in the FIG. 2. The next SCP hop is the SCPy (216) based on the routing path. The SCPx (214) decrements the allowed intermediate SCP hop number by 1 to set the new routing path detection information as N−3. If the N is set 3, in this case, the SCPx (214) sends the request message comprising the new routing path detection information with value 0 towards the SCPy (216) in step 205.

The SCPy (216) receives the request message from SCPx (214) in step 205. If the next hop is SCP based on the routing path, the SCPy (216) determines the routing path is dead looping based on the received original routing path detection information from the SCPx (214). The maximum number of allowed SCPs is reached based on that the current value of the original routing path detection information is 0 then the next SCP hops is not allowed. The SCPy (216) sends a response message towards the SCPx (214) to reject the request message and the response message comprises response code and/or application error indicating the reason of rejecting the request message; wherein the application error comprises value to indicate the request is rejected due to the maximum number of allowed SCP hops has been reached when relaying the request message to a target Network Function. If the next hop is another NF based on the routing path, the SCPy (216) sends the request message to the another NF.

When the SCPx (214) receives the response message with the response code and/or application error, it transmits the response message to another SCP or NF from which the request message is received.

There is a draft proposal for update the 3GPP 29.500 (16.5.0) to introduce custom header “3gpp-Sbi-Max-Scp-Hops” which is used to indicate the max allowed SCP hops remaining to reach the target HTTP server. The proposed update is highlighted as below.

### 5.2.3.2.1 General

The 3GPP NF Services shall support the HTTP custom headers specified in Table 5.2.3.2.1-1 below. A description of each custom header and the normative requirements on when to include them are also provided in Table 5.2.3.2-1.

TABLE 5.2.3.2.1-1
Mandatory HTTP custom headers

| Name | Reference | Description |
|---|---|---|
| 3gpp-Sbi-Client-Credentials | Clause | This header may be used by an NF Service Consumer to send |
| | 5.2.3.2.11 | Client Credentials Assertion to the NRF or to the NF Service |
| | | Producer. See clause 6.7.5. |
| . . . | . . . | . . . |
| 3gpp-Sbi-Nrf-Uri | Clause | This header may be used to indicate the NRF API URIs to be |
| | 5.2.3.2.12 | used for a given service request, e.g. in indirect communication |
| | | with delegated discovery as a result of an NSSF query. |
| 3gpp-Sbi-Max-Scp-Hops | Clause | This header may be used to indicate the maximum number of |
| | 5.2.3.2.x | allowed SCP hops to relay the request message to the HTTP |
| | | server when indirect communication is used. |

### 5.2.3.2.x 3gpp-Sbi-Max-Scp-Hops

The header contains the value of maximum number of allowed SCP hops to relay the request message to the target NF.
The encoding of the header follows the ABNF as defined in IETF RFC 7230 [12].
3gpp-Sbi-Max-Scp-Hops=“3gpp-Sbi-Max-SCP-Hops”“:”OWS (“0”/%×31-39*DIGIT)
An example is: 3gpp-Sbi-Max-Scp-Hops: 5.

[symbol]

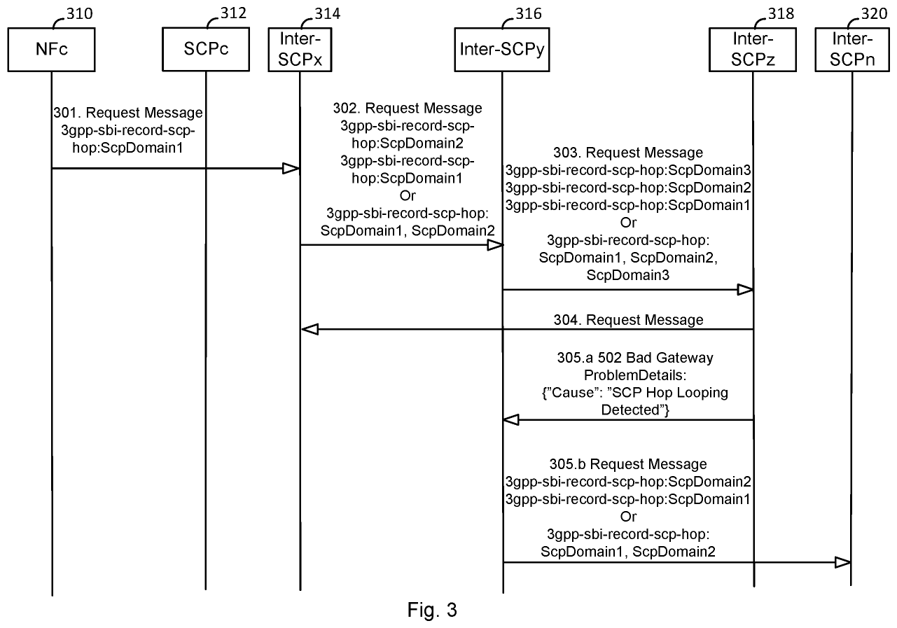

FIG. 3 is a diagram illustrating another exemplary procedure for detection dead loop in SCP routing according to some embodiments of the present disclosure. NFc (310) and SCPc (312) belong to sameScpDomain1, SCPx (314), SCPy (316) and SCPz (318) are intermediate SCP(s) belongs to the ScpDomain2, ScpDomain3 and ScpDomain4 respectively, which can bridge the request message from the SCPc (312) to the SCPn (320).

As shown in FIG. 3, in step 301, the NFc (310) sends request message to SCPx (314) via the SCPc (312), the request message comprises the original routing path detection information to detect dead looping in the routing path and the original routing path detection information is recorded domain and/or SCP Id(s), the recorded SCP domains and/or SCP Ids indicates the SCP domains or SCP Ids within which the request message is being bridged.

In some embodiment of this present disclosure, the request message is a HTTP request message, and the HTTP message header comprises 3gpp-sbi-record-scp-hop: ScpDomain1 which indicates ScpDomain1 is being bridged to relay the request message to the HTTP server when indirect communication is used. And in some embodiment of this present disclosure, the SCPx (314) may receive the request message from a NF (i.e., NFc (310) directly.

When the SCPx (314) receives the request message in step 301, the next hop is SCPy (316) based on the routing path. The SCPx (314) determines if the routing path is dead looping based on the original routing path detection information. As described above, SCPy (316) belongs to ScpDomain2 which is not within the recorded SCP domains, and the SCP Id of the SCPy (316) is not within the recorded SCP Ids. Then the determining result indicates that the routing path is not dead looping. The SCPx (314) generates the new routing path detection information by inserting the ScpDomain2 to the recorded Domains and/or inserting the SCP Id of SCPx (314) into the recorded SCP Id(s). Then the SCPx (314) sends the request message comprising the new routing path detection information towards the SCPy (316) in step 302.

The SCPy (316) receives the request message from SCPx (314) in step 302, similar as the description above, the SCPy (316) generates the new routing path detection information by adding the ScpDomain3 to the recorded Domains, and sends the request message comprising the new routing path detection information towards the SCPy (318) in step 303.

The SCPy (318) receives the request message from SCPy (316) in step 303 and the next SCP hop is the SCPx (314) based on the routing path as indicated in step 304, the SCPy (318) determines that the routing path is dead looping since the ScpDomain2 associated to the SCPx (314) is within the recorded ScpDomains. The SCPy (318) sends a response message towards the SCPy (316) to reject the request message and the response message comprises response code and/or application error indicating the reason of rejecting the request message.

In some embodiments of the present disclosure, if the next hop is another NF, the SCPy (318) sends the request message to the another NF based on the routing path.

In some embodiments of the present disclosure, when the total number of intermediate SCP in the path is allowed, the SCPy (316) sends the request message to other SCPn which is not present in the recorded SCP domains in the step 305b after receiving a response message indicating the request message is rejected.

In some embodiments of the present disclosure, the SCPy (316) may inform the result of the trying sending the request message to the other SCPn (320). When all SCP domains that can reach target NF by configuration have been tried unsuccessfully. The SCPy (316) may inform information of dead loop in routing path to an operating and managing system and/or NF indicating the operating and managing system and/or NF update or fix misconfiguration for the routing path. It will be appreciated that signaling messages and network elements shown in FIGS. 2-3 are just as examples, and more or less alternative signaling messages and network elements may be involved in routing according to the embodiments of the present disclosure.

In some embodiments of the present disclosure, the solution described in FIG. 2 and the solution described in FIG. 3 may be applied together.

It is noted that some embodiments of the present disclosure are mainly described in relation to LTE or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments and does naturally not limit the present disclosure in any way. Rather, any other system configuration or radio technologies may equally be utilized as long as exemplary embodiments described herein are applicable.

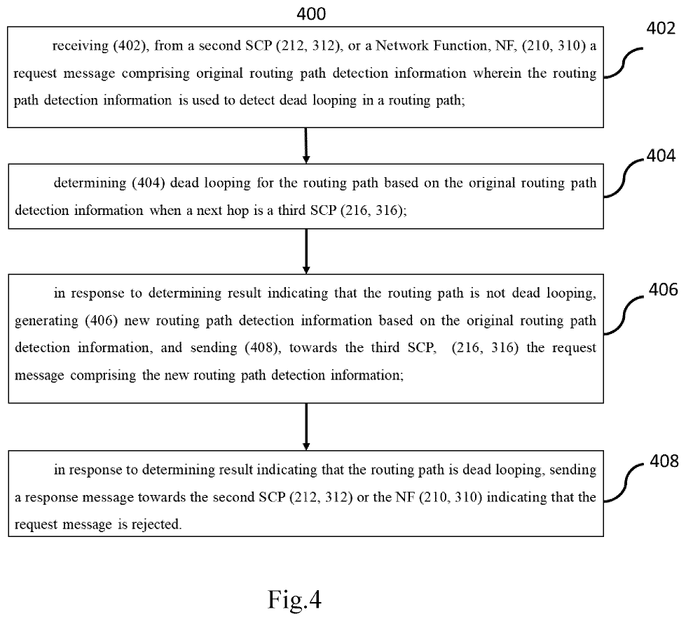

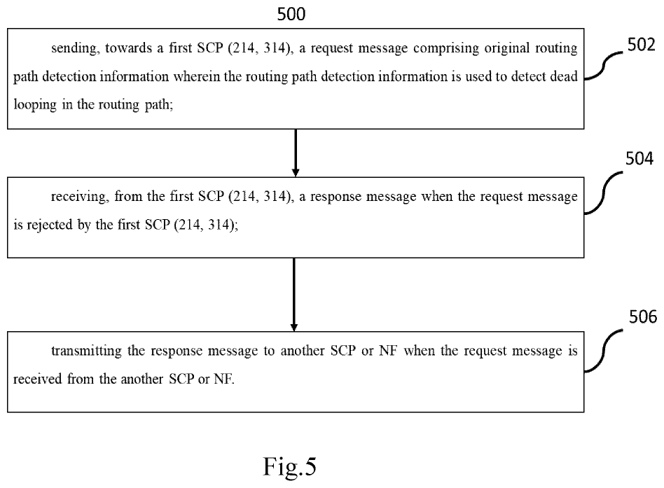

The various blocks shown in FIGS. 4-5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

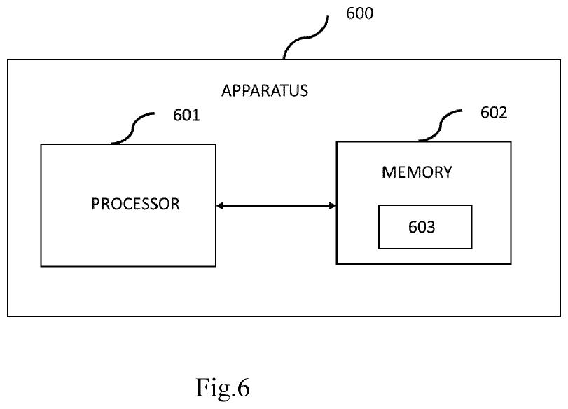

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a first SCP as described with respect to FIG. 4, a second SCP or NF entity as described with respect to FIG. 5.

In some implementations, the one or more memories 602 and the computer program codes 603 may be configured to, with the one or more processors 601, cause the apparatus 600 at least to perform any operation of the method as described in connection with FIG. 4. In some implementations, the one or more memories 602 and the computer program codes 603 may be configured to, with the one or more processors 601, cause the apparatus 600 at least to perform any operation of the method as described in connection with FIG. 5.

Alternatively or additionally, the one or more memories 602 and the computer program codes 603 may be configured to, with the one or more processors 801, cause the apparatus 600 at least to perform more or less operations to implement the proposed methods according to the exemplary embodiments of the present disclosure.

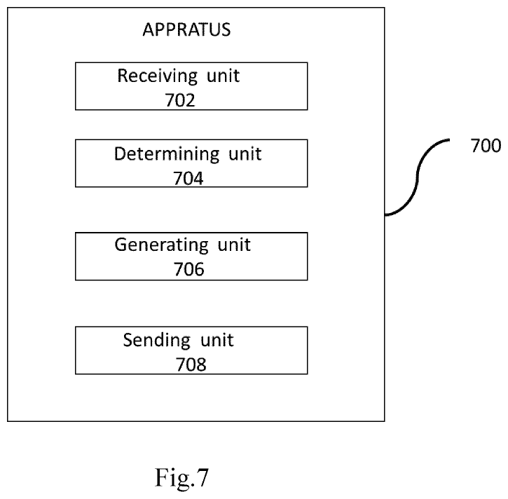

FIG. 7 is a block diagram illustrating an apparatus 700 according to some embodiments of the present disclosure. The apparatus 700 may be implemented as a first SCP or as a part of the first SCP. As shown in FIG. 7, the apparatus 700 may comprise a receiving unit 702, a determining unit 704, a generating unit 706, a sending unit 708. In an exemplary embodiment, the apparatus 700 may be implemented in a first SCP. The receiving unit 702 may be operable to carry out the operation in block 402, and the determining unit 704 may be operable to carry out the operation in block 404. The Generating unit 706 may be operable to carry out the operation in block 406, and the sending unit 708 may be operable to carry out the operation in block 408. Optionally, the receiving unit 702 and/or the determining unit 704 and/or generating unit 706 and/or the sending unit 708 may be operable to carry out more or less operations to implement the proposed methods according to the exemplary embodiments of the present disclosure.

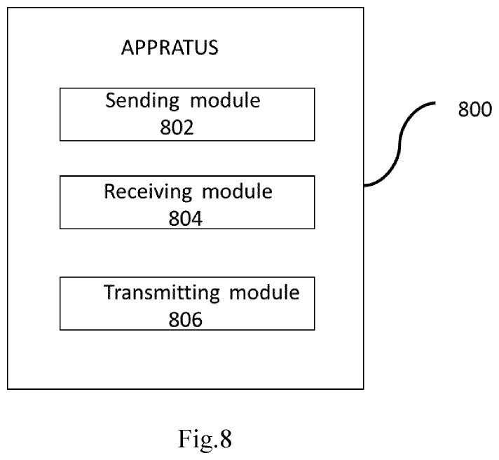

FIG. 8 is a block diagram illustrating an apparatus 800 according to some embodiments of the present disclosure. The apparatus 800 may be implemented as a second network node or as a part of the second network node. As shown in FIG. 8, the apparatus 800 may comprise a sending unit 802 and a receiving unit 804 and a transmitting unit 806. In an exemplary embodiment, the apparatus 800 may be implemented in a second SCP or NF entity. The sending unit 802 may be operable to carry out the operation in block 502, and the receiving unit 804 may be operable to carry out the operation in block 504, and the transmitting unit 806 may be operable to carry out the optional operation in block 506. Optionally, the sending unit 802 and/or the receiving unit 804 and/or the transmitting unit 806 may be operable to carry out more or less operations to implement the proposed methods according to the exemplary embodiments of the present disclosure.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-21. (canceled)

22. A method performed by a first Service Communication Proxy, SCP, comprising:
receiving, from a second SCP, or a Network Function, NF, a request message comprising original routing path detection information, wherein the routing path detection information is used to detect dead looping in a routing path, and the original routing path detection information comprises a value indicating maximum number of allowed intermediate SCPs to relay the message;
determining dead looping for the routing path based on the original routing path detection information when a next hop is a third SCP; wherein the determining dead looping comprises: the determining result indicating that the routing path is dead looping when the value indicating that no more allowed intermediate SCPs to relay the message; or the determining result indicating that the routing path is not dead looping when the value indicating that there is allowed intermediate SCPs to relay the message;
in response to the determining result indicating that the routing path is not dead looping, generating new routing path detection information based on the original routing path detection information, and sending, towards the third SCP, the request message comprising the new routing path detection information; and
in response to the determining result indicating that the routing path is dead looping, sending a response message towards the second SCP or the NF indicating that the request message is rejected.

23. The method according to claim 22, wherein the generating new routing path detection information comprises:
decrementing the number of the allowed intermediate SCPs by 1 to set the new routing path detection information when the value indicating there is allowed intermediate SCPs.

24. The method according to claim 22, wherein the request message is a Hypertext Transfer Protocol, HTTP, message, and the HTTP message header comprises the routing path detection information.

25. The method according to claim 22, wherein the response message comprises a response code and/or application error indicating a reason of rejecting the request message; wherein the application error comprises a value to indicate that the request is rejected due to the maximum number of allowed SCPs being reached before reaching a target Network Function.

26. A method performed by a second Service Communication Proxy, SCP, or a Network Function, NF, comprising:
sending, towards a first SCP, a request message comprising original routing path detection information wherein the routing path detection information is used to detect dead looping in the routing path;
receiving, from the first SCP, a response message when the request message is rejected by the first SCP; and
transmitting the response message to another SCP or NF when the request message is received from the another SCP or NF.

27. The method according to claim 26, wherein the original routing path detection information comprises a value indicating a maximum number of allowed intermediate SCPs to relay the message.

28. The method according to claim 26, wherein the request message is a Hypertext Transfer Protocol, HTTP, message and the HTTP message header comprises the value of the routing path detection information.

29. The method according to claim 26, wherein the response message comprises a response code and/or application error indicating the reason of rejecting the request message, wherein the application error comprises information to indicate the request is rejected due to the maximum number of allowed SCP hops being reached before reaching a target Network Function.

30. The method according to claim 26, further comprising:
informing information of dead looping in the routing path to an operating and managing system and/or NF indicating the operating and managing system and/or NF update or fix misconfiguration for the routing path when all SCP domains that can reach target NF by configuration have been tried unsuccessfully.

31. The method according to claim 26, wherein the original routing path detection information is obtained from one of:
a message transmitted from another SCP or NF; or
configuration information.

32. A first Service Communication Proxy, SCP, comprising:
one or more processors; and
one or more memories comprising computer program codes,
the one or more memories and the computer program codes configured to, with the one or more processors, cause the first SCP to perform the method according to claim 22.

33. A second Service Communication Proxy, SCP, or Network Function, NF, comprising:
one or more processors; and
one or more memories comprising computer program codes,
the one or more memories and the computer program codes configured to, with the one or more processors, cause the second SCP or NF at least to perform the method according to claim 26.
